(19) United States
(12) Patent Application Publication
(10) Pub. No.: US 2023/0087064 A1
(43) Pub. Date: Mar. 23, 2023

(54) DETECTION DEVICE AND DETECTION SYSTEM FOR ACTIVATING AT LEAST ONE FUNCTION OF AN APPARATUS, AND APPARATUS COMPRISING THE DETECTION SYSTEM

(71) Applicant: U-Shin Italia S.p.A., Pianezza (IT)

(72) Inventors: Anthony GUERIN, Pianezza (IT); Myriam AKANOU, Pianezza (IT); Antonio LABALESTRA, Pianezza (IT)

(73) Assignee: U-Shin Italia S.p.A., Pianezza (IT)

(21) Appl. No.: 17/950,649

(22) Filed: Sep. 22, 2022

(30) Foreign Application Priority Data
Sep. 23, 2021 (EP) 21198668.2

(51) Int. Cl. E05B 81/76; E05B 85/16; E05B 81/16

(52) U.S. Cl. CPC E05B 81/76; E05B 85/16; E05B 81/16

(57) ABSTRACT

A device includes an apparatus, including a fixed part attached to an activation part, and at least one detection device configured to activate at least one function of the apparatus upon detection of force applied to the activation part. Every detection device of the at least one detection device includes a blade and a sensor. The blade includes first and second bearing parts that bear against the activation part or the fixed part. The sensor is on the blade between the first and second bearing parts. The sensor measures deformation of the blade when the force is applied on the activation part and collects a deformation signal to be transmitted to a controller. At least one of the first bearing part and the second bearing part is secured to the activation part or to the fixed part by at least one overmolded securing portion.

### CROSS-REFERENCE TO RELATED APPLICATIONS

This application claims priority to and the benefit of EP 21198668.2, filed on Sep. 23, 2021. The disclosure of the above application is incorporated herein by reference.

### FIELD

The present disclosure relates to a detection device for activating at least one function of an apparatus, for example for activating an electric lock of a vehicle's door.

### BACKGROUND

The statements in this section merely provide background information related to the present disclosure and may not constitute prior art.

It is known from the state of the art that touch and/or pressure-sensitive sensors and proximity sensors can be provided for the opening of electronic door lock, for example of a vehicle. Such sensors can be used, for example, on a door handle in order to detect contact with the door handle. Most of the pressure sensors are accessible from the outside of the handle in order to achieve a successful measurement. In response to a detection by the corresponding sensor, a vehicle function can be activated, such as activation of an electronic lock for example. Thus, for example, the door can be opened by touching the door handle of a door. However, this creates installation difficulties. For example, it is typically necessary to provide a seal to prevent against moisture ingress. There is, therefore, a need for a more reliable and/or more accurate and/or simpler option for activating vehicle functions.

### SUMMARY

This section provides a general summary of the disclosure and is not a comprehensive disclosure of its full scope or all of its features.

In one form, the present disclosure is directed toward a detection device for activating at least one function of an apparatus, e.g., activating an electric lock of a vehicle's door, upon the detection of a force applied to an activation part of the apparatus. The apparatus further includes a fixed part. The activation part is fixedly attached to the fixed part. In this form, the detection device includes a blade and at least one sensor. The blade includes a first bearing part and a second bearing part. The first bearing part and the second bearing part both bear against the activation part or the fixed part. The at least one sensor is arranged on a sensor location of the blade located between the first bearing part and the second bearing part and is configured to measure a deformation of the blade when a force is applied on the activation part and collect deformation signal to be transmitted to a controller. At least one of the first bearing part and the second bearing part is secured to the activation part or to the fixed part by an overmolded securing portion.

In one form, the activation is configured to be activated by a user. In other words, the user may apply a force to the activation part when they intend to activate the function of the apparatus. Therefore, the force applied to the activation part allows a deformation of the blade.

The detection device according to the present disclosure is more accurate and reliable than typical detection devices. Due to the blade being secured to the fixed part or the activation part by at least one overmolded portion, the blade is more sensitive to deformation induced by the force applied to the activation part by the user.

Moreover, the use of a blade allows measuring a deformation of the fixed part or the activation part more directly.

The detection device according to the present disclosure also improves the comfort of the user. The mounting of the detection device on the apparatus is also easier and, therefore, more cost effective.

In one form, the signal is representative of a deformation data.

In another form, the apparatus may be mounted on an assembly. For example, the assembly can be a door of a vehicle. In one form, the fixed part is the part of the apparatus configured to be integrally mounted on the assembly.

In one form, the function may be a function of an electric lock, such as an opening/closing or a locking/unlocking function.

In another form, the first bearing and second bearing parts may be secured to the activation part or the fixed part.

In still another form, the first and second bearing parts may be firmly secured to the activation part or the fixed part.

In one form, one of the first and second bearing parts may be attached to the activation part via a screw.

In another form, the first bearing part may be secured to the activation part by at least one overmolded securing portion and/or the second bearing part may be secured to the activation part by at least one overmolded securing portion.

In another form, the first bearing part may be secured to the fixed part by at least one overmolded securing portion and/or the second bearing part may be secured to the fixed part by at least one overmolded securing portion.

In one form, the blade may be positioned in the mold for manufacturing the activation part or the fixed part, when the fixed part or the activation part is manufactured.

In one form, the overmolded securing portion is formed with the activation part or with the fixed part.

In another form, both the first bearing part and the second bearing part may be secured to the activation part or to the fixed part by the overmolded securing portion, herein after called the first overmolded securing portion and a second overmolded securing portion.

In one form, the sensor location may be formed in a recess between the first overmolded securing portion and the second overmolded securing portion. Thus, the sensor location and/or the sensor is not overmolded and measures only the deformation of the blade.

Therefore, the sensor location can be accessed to secure the sensor on the sensor location once the blade is secured by the first and second overmolded securing portions.

In one form, the blade may be secured to the fixed part or the activation in the vicinity of the mounting area of the activation part on the fixed part.

In another form, the sensor may be positioned on one or the other face of the blade.

In yet another form, the sensor may be positioned on a face of the blade configured to bear against the overmolded securing portion. This face of the blade may be facing the outside.

In one form, the sensor may be positioned on the face of the blade opposite to the face configured to bear against the overmolded securing portion. This face of the blade may be facing the inside of the fixed part or the activation part, for example, an internal cavity of the fixed part or the activation part.

In yet another form, the overmolded securing portion may protrudes from an external envelope of the fixed part or the activation part.

In one form, the blade may be made of metal material. For example, the blade may be made of steel.

In one form, the stiffness and elasticity of the blade is configured to be adapted such that the sensor is able to accurately measure the deformation of the blade.

In still another form, the width of a portion of the blade where the sensor is arranged may be between 0.5 and 1.5 mm.

In one form, the width of a portion of the blade where the sensor is arranged may be between 0.6 and 1 mm.

In yet another form, the width of a portion of the blade where the sensor is arranged may be substantially 0.8 mm.

In another form, the sensor may be adhered to the blade. The mounting of the sensor on the blade is therefore simple and do not incur important costs.

In one form, the sensor may be a strain gage sensor.

In another form, the sensor may comprise one or several resistance(s).

In still another form, the sensor may be a full-bridge strain gage.

In yet another form, the sensor may be a half-bridge strain gage.

In one form, the detection device may comprise a housing. The sensor may therefore be protected by the housing.

In still another form, the housing may be configured to protect the sensor.

In yet another form, the housing may be positioned over the face of the blade on which the sensor is arranged.

In another form, the housing may be made of plastic material.

In one form, the sensor may be sandwiched between the blade and the housing.

In still another form, the sensor is configured to measure a deformation of the blade when a force is applied on the activation part and collect deformation signal to be transmitted to a controller.

In one form, the blade may comprise positioning elements configured to help positioning the blade on the activation part and/or the fixed part during a mounting phase.

In a further form, the present disclosure is directed toward a detection system for activating at least one function of an apparatus, e.g., for activating an electric lock of a vehicle's door, upon the detection of a force applied to an activation part of the apparatus. The apparatus further includes a fixed part. The activation part is fixedly attached to the fixed part. The detection system includes at least one detection device and a controller. The at least one detection device can be according to any one of the above mentioned features. The controller is configured to receive the deformation signal transmitted by the sensor of the at least one detection device and to activate at least one function of an apparatus when the deformation signal corresponds to predetermined criteria.

In one form, the predetermined criteria may correspond to a predetermined range of the numeral values of the signal and/or a predetermined range of the duration of a modification of the signal and/or a predetermined range of the speed of a modification of the signal.

In one form, the modification of the signal is a rise or a decrease of the value of the signal relatively to a rest value of the signal. The rest value corresponds to the absence of deformation of the blade.

In another form, the limit values of the range of the signal value and/or the limit values of the duration range of a modification of the signal and/or the limit values of the speed range of a modification of the signal may be chosen in accordance with the aging of the detection device and/or the outside temperature.

In one form, these predetermined criteria are chosen such that the function of the apparatus is not activated by modifications of the signal that may be due to the aging of the detection device and/or a variation of the outside temperature.

In yet a further form, the present disclosure is directed toward an apparatus, e.g., a handle of a vehicle's door, including a fixed part, an activation part being fixedly attached to the fixed part, and at least one detection system according to the above mentioned features.

In one form, the apparatus may be a handle of a door, e.g., a vehicle's door, or any other apparatus, such as a motorized flap.

In another form, the activation part may be fixedly attached to the fixed part in a first mounting area and in a second mounting area, a first detection device being arranged in the first mounting area and a second detection device being arranged in the second mounting area.

Further advantages and advantageous features of the door handle apparatus are disclosed in the following description.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a front perspective view of an activation part of a doorhandle of a door, in accordance with the teachings of the present disclosure;

FIG. 2 is a front view of the door handle of FIG. 1, illustrated without an external cover;

FIG. 3 is a rear view of the door handle of FIG. 1, according to a first construction;

FIG. 4 is a perspective view of a first mounting area and a first detection device of the door handle of FIG. 1;

FIG. 5 is a perspective view of a second mounting area and a second detection device of the door handle of FIG. 1; and

FIG. 6 is a perspective view of a blade of a detection device of the door handle of FIG. 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the following description, positioning terms such as front, back, left, right, etc., refer to an orthogonal basis comprising the following three directions: front-back, left-right and top-bottom. In this description, theses three directions correspond to the usual directions attached to the motor vehicle. However, the teachings of the present disclosure can apply to other forms in which the directions front-back, left-right and top-bottom could be any set of arbitrary directions forming an orthogonal basis.

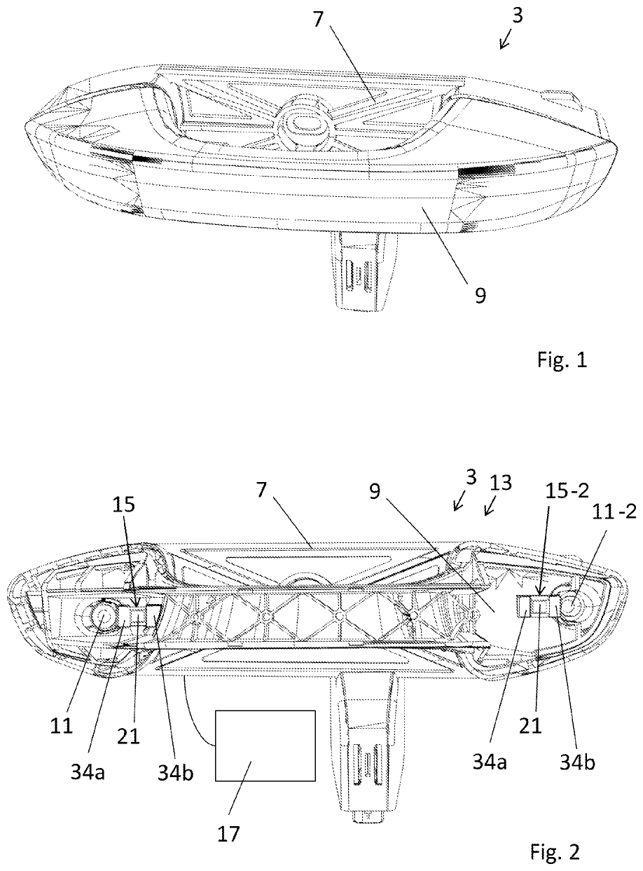

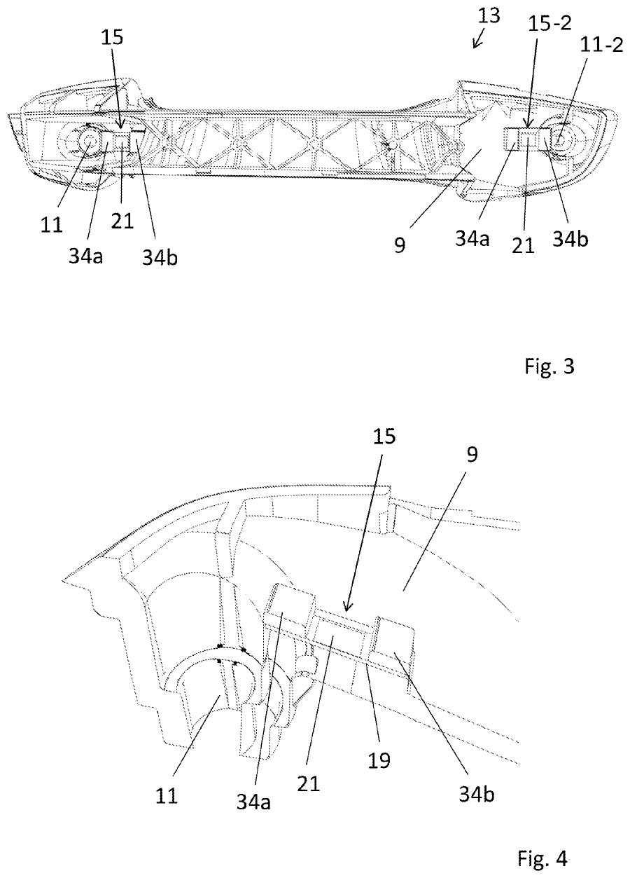

FIGS. 1 to 6 show one form of an apparatus according to the present disclosure, wherein the apparatus is a handle 3 of a vehicle door (not shown) of a vehicle, wherein the activation part 9 is a gripping part, protruding from the outer wall of the door. In another form, the apparatus may be a motorized flap for example.

The handle 3 includes a fixed part 7, corresponding to a bracket of the handle 3, integral with the door (not shown) of the vehicle, and an activation part 9. The activation part 9 is firmly attached to the fixed part 7. The activation part 9 may optionally be in polycarbonate. The activation part 9 is configured to be activated by a user. The activation part 9 is movable relatively to the fixed part 7 at a scale wherein the movement of the activation part 9 is not detectable by the user. In other words, when pulling or pushing the activation part 9, the user feels that the activation part 9 is fixedly attached to the fixed part 7 even though the activation part 9 slightly moves relative thereto.

The handle 3 further comprises one detection system 13 configured to activate at least one function of the handle 3 upon the detection of a force applied to the activation part 9 by the user. The function may be a function of an electric lock (not shown) of the vehicle door (not shown), such as an opening/closing or a locking/unlocking function. The detection system 13 includes, in the example provided, a first detection device 15, a second detection device 15-2 and a controller 17. The controller 17 may be positioned in the fixed part 7 or in the activation part 9 or in the vehicle door, for example.

The activation part 9 is mounted on the fixed part 7 at two mounting areas 11, 11-2. The detection system 13 includes the first detection device 15, arranged at the first mounting area 11 and the second detection device 15-2 arranged at the second mounting area 11-2.

The detection system 13 includes one controller 17 for both the detection devices 15, 15-2. In another form, the detection system 13 may include a first controller configured to communicate with the first detection device 15 and a second controller configured to communicate with the second detection device 15-2.

The first detection device 15 is described in the following description. The second detection device 15-2 can be similar to the first detection device 15, except as otherwise shown or described herein. Accordingly, the description of the first detection device 15 also applies to the second detection device 15-2. As such, the first detection device 15 is generally called herein after the detection device 15. The detection device 15 includes a blade 19. The detection device 15 includes a sensor 21 arranged on the blade 19 and configured to measure the deformation of the blade 19 when a force is applied to the activation part 9 and to transmit a deformation signal to the controller 17.

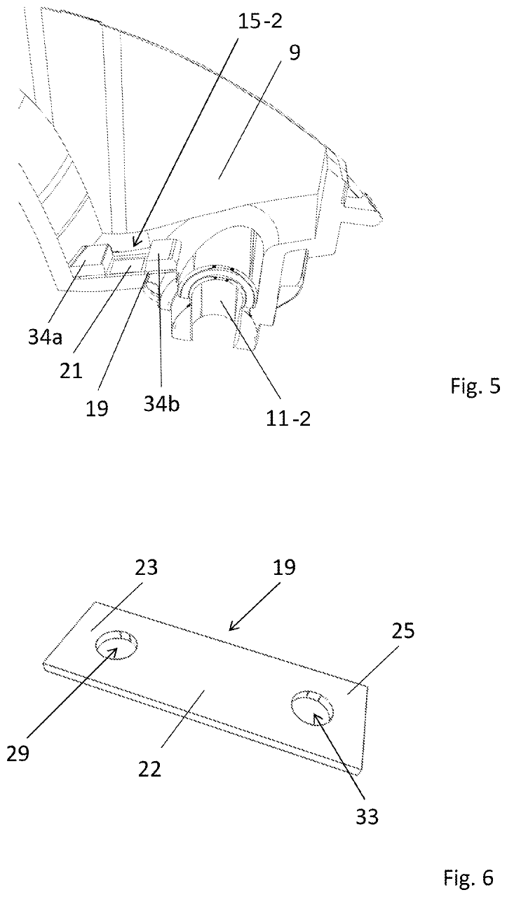

Referring to FIG. 6, the blade 19 includes a first bearing part 23 and a second bearing part 25 configured to bear against the activation part 9. The first and second bearing parts 23, 25 are secured to the activation part 7 via overmolded securing portions 34a, 34b.

The overmolded securing portions 34a, 34b are formed with the activation part 7.

The sensor 21 is configured to be arranged on the blade 19 at a sensor location 22 of the blade 19 between the first bearing part 23 and the second bearing part 25.

The material and the thickness of the sensor location of the blade 19 where the sensor 21 is arranged are adapted such that the blade 19 deforms at this location when the user applies a force on the activation part 9.

In the example provided, the force applied by the user may be between 5 and 100 N. In one form, the force applied by the user may be between 10 and 40 N.

For example, the thickness of the sensor location 22 is between 0.5 and 1 mm. For example, the thickness of the sensor location 22 is substantially 0.8 mm.

The blade 19 may be of metal material such as steel.

In the example provided, the sensor 21 is adhered to the blade 19. In an alternative form, the sensor 21 may be fixed to the blade 19 by any other suitable means known by the skilled person.

The sensor 21 may have a thickness between 0.2 and 0.8 mm. In one form, the sensor 21 may have a thickness of 0.5 mm.

The sensor 21 may communicate with the controller 17 by wire, or by any other suitable communication means known by the skilled person.

In the example provided, the first bearing part 23 comprises a first hole 29 and the second bearing part 25 comprises a second hole 33. The first and second holes 29, 33 are positioning holes, configured to help positioning the blade on the activation part 9.

When the user pulls the activation part, the force applied by the user generates a deformation of the activation part 9 and, therefore, a deformation of the blade 19. The sensor 21 is configured to generate a deformation signal based on the deformation of the blade 19.

The controller 17 is then configured to collect the deformation signal transmitted by the sensor 21 and to activate the at least one function of the handle 3 when the deformation signal corresponds to predetermined criteria.

The predetermined criteria may correspond to a predetermined range of the numeral values of the signal and/or a predetermined range of the duration of a modification of the signal and/or a predetermined range of the speed of a modification of the signal.

The modification of the signal is a rise or a decrease of the value of the signal relatively to a rest value of the signal, the rest value corresponding to the absence of deformation of the blade.

The limit values of the range of the signal value and/or the limit values of the duration range of a modification of the signal and/or the limit values of the speed range of a modification of the signal may be chosen in accordance with the aging of the detection device 15 and/or the outside temperature.

These predetermined criteria are chosen such that the function of the apparatus is not activated by modifications of the signal that may be due to the aging of the detection device 15 and/or a variation of the outside temperature.

It is to be understood that the present disclosure is not limited to the forms described above and illustrated in the drawings; rather, the skilled person will recognize that many changes and modifications may be made within the scope of the appended claims.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A device comprising:
apparatus including a fixed part and an activation part fixedly attached to the fixed part; and
at least one detection device configured to activate at least one function of the apparatus upon detection of a force applied to the activation part of the apparatus, every detection device of the at least one detection device including:
a blade including a first bearing part and a second bearing part, wherein the first bearing part and the second bearing part both bear against the activation part or the fixed part; and
at least one sensor arranged on the blade on a sensor location of the blade that is located between the first bearing part and the second bearing part, wherein the at least one sensor is configured to measure a deformation of the blade when the force is applied on the activation part and collect a deformation signal to be transmitted to a controller,
wherein at least one of the first bearing part and the second bearing part is secured to the activation part or to the fixed part by at least one overmolded securing portion.

2. The device according to claim 1, wherein the at least one overmolded securing portion includes a first overmolded securing portion and a second overmolded securing portion, wherein the first bearing part is secured to the activation part or to the fixed part by the first overmolded securing portion, wherein the second bearing part is secured to the activation part or to the fixed part by the second overmolded securing portion.

3. The device according to claim 2, wherein the sensor location is formed in a recess between the first overmolded securing portion and the second overmolded securing portion.

4. The device according to claim 1, wherein the blade is made of metal material.

5. The device according to claim 1, wherein the at least one sensor is adhered to the blade.

6. The device according to claim 1, wherein the at least one sensor is a strain gage sensor.

7. The device according to claim 6, wherein the at least one sensor is a full-bridge strain gage.

8. The device according to claim 6, wherein the at least one sensor is a half-bridge strain gage.

9. The device according to claim 1, further comprising the controller configured to receive the deformation signal transmitted by the at least one sensor and to activate the at least one function of the apparatus when the deformation signal corresponds to predetermined criteria.

10. The device according to claim 9, wherein the apparatus is a handle of a vehicle door.

11. The device according to claim 10, wherein the at least one detection device includes a first detection device and a second detection device, the first detection device being arranged at a first location of the fixed part and the second detection device being arranged at a second location of the fixed part.

12. The device according to claim 11, wherein the first and second locations of the fixed part are spaced apart.

13. The device according to claim 11, wherein the activation part is fixedly secured to the fixed part at a first mounting area and at a second mounting area, wherein the first and second locations of the fixed part are at the first and second mounting areas respectively.

14. The device according to claim 10, wherein the at least one detection device includes a first detection device and a second detection device, the first detection device being arranged at a first location of the activation part and the second detection device being arranged at a second location of the activation part.

15. The device according to claim 14, wherein the first and second locations of the activation part are spaced apart.

16. The device according to claim 14, wherein the activation part is fixedly secured to the fixed part at a first mounting area and at a second mounting area, wherein the first and second locations of the activation part are at the first and second mounting areas respectively.
